(19) United States
(12) Patent Application Publication
(10) Pub. No.: US 2002/0191951 A1
(43) Pub. Date: Dec. 19, 2002

(54) Image recording apparatus

(75) Inventors: Ken Sodeyama, Hitachinaka (JP); Tomishige Yatsugi, Hitachinaka (JP); Morio Aoki, Hitachinaka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/105,720

(22) Filed: Mar. 20, 2002

(30) Foreign Application Priority Data
Jun. 15, 2001 (JP) 2001-181013
Dec. 19, 2001 (JP) 2001-385435

(51) Int. Cl. H04N 5/76; H04N 5/225

(52) U.S. Cl. 386/46; 386/111; 386/117

(57) ABSTRACT

A conventional image recording apparatus like a video camera recorder may often bring about coding noises if an image to be inputted or a target object reaches a certain degree of complexity. The remaining time when data is to be recorded on a recording medium may be so varied according to the magnitude of the coding rate that the time cannot be easily grasped. To overcome these problems, the present image recording apparatus is arranged to vary the display based on the coding rate according to the magnitude of the coding rate so that the user can grasp how much the coding noises appear with sense. Further, by displaying the remaining volume and the coding rate of the recording medium associated therewith, the decreasing pace of the remaining time may be notified to the user.

### BACKGROUND OF THE INVENTION

The present invention relates to a technology of recording or reproducing an image.

The conventional apparatus of compressively coding an video signal and recording the resulting signal has difficulty in enhancing an apparent coding rate to 10 Mbps or higher if the apparatus adopts the HYPERLINK mail to: MP@ML MP@ML (Main Profile@Main Level) of the MPEG-2 Standards. In particular, a disk recording apparatus has difficulty in making the recordable time shorter in reverse proportion to the coding rate. Further, the MPEG-2 coding is characterized to make the recording coding rate set lower against the noncompressive coded video signal, so that if the apparent coding rate is set to as high a coding rate as 10 Mbps, the MPEG-2 coding loses its characteristics. This type of disk recording apparatus is normally characterized to set the recording coding rate to be 5 to 7 Mbps, which is known as the normal coding rate for obtaining the image quality to be used for the broadcast.

In the foregoing image compressing technology, on the other hand, it is known that the most approximate coding rate after compression is varying according to the complexity of the image to be inputted into the compressing apparatus. In a case that the upper limit value of the recording coding rate is determined by selecting the compressing rate, the image having a complex pattern is inputted into a stay-at-home model disk recorder provided with the MPEG-2 image compression, or the image compression technology is applied to a video camera, when a quite complex object existing in the natural world is imaged through a lens, a moving object is imaged, or an object is imaged as moving a lens, the compressed image may bring about coding noises.

That is, in such an apparatus as digitizing an input image and recording the digital data on a disk, in particular, a video camera or a video recorder to which an optical disk is applied and having a highly efficient coding technology called the MPEG, unnatural noises called the coding noises may be brought about on some kind of input images. The principle on which the coding noises are generated will be described in the section “Description of the Preferred Embodiments”.

From the foregoing description, in the allowable range of the recording coding rate, for example, the apparatus of applying the foregoing compressing technology to the video camera like a stay-at-home model video recorder needs means of notifying the user of whether or not the coding rate of the inputted image exceeds the upper limit value of the recording coding rate.

### SUMMARY OF THE INVENTION

In the recording apparatus of digitizing the video signal, compressing and coding the digital signal, and recording the result, at the normal recording coding rate, the coding noises may appear in some kind of complex image to be inputted, or complex object to be imaged. An object of the present invention is to solve the problem that though that kind of coding noises may appear, the user of the recording apparatus cannot get to know the noises appearing inside of the coding unit until the recorded image is decoded and reproduced. Concretely, an object of the present invention is to provide means of notifying the user of the apparent or possible coding noises that may appear according to the complexity of an object to be imaged so that the user can grasp the apparent or possible noises while recording the object and adjust the state, the position, the pattern or the background of the object if possible for the purpose of avoiding the appearance of the coding noises.

In place, the foregoing coding noises may be avoided by setting the coding rate to the most approximate one. However, in the case of recording information on the recording medium, the recordable time is variable according to the coding rate. For example, for a complex image, a higher coding rate needs a larger volume for recording information per unit time. Hence, for the unrecorded portion of the volume (remaining volume), a higher coding rate for recording makes the remaining recordable time shorter, while a lower coding rate for recording makes the remaining recordable time longer.

The change of the coding rate leads to increasing or decreasing the remaining recordable time. Ordinarily, the remaining time can be obtained by the following Expression (1):

(Remaining Time)=(Total Volume−Recorded Volume)/(Coding Rate) (1)

In the Expression (1), the change of the coding rate leads to changing the remaining time. For example, in a case that the coding rate for later recording is higher than the coding rate used for calculating the remaining time displayed at a time point when recording the image data, it means that the time when the data is to be recorded on the recording medium is shorter than the remaining time displayed at that time point. In this case, the to-be-recorded image portion corresponding to a shortage of time is out of recording. This is a problem. Hence, a further object of the invention is to provide a method of notifying an imager of the remaining time.

As means of solving the foregoing problems, in an image recording apparatus, means of displaying a higher coding rate than a predetermined rate is provided in means of compressing and coding an image. Further, this displaying means is arranged so that a value of displaying the coding rate is made larger according to a complexity level of an image to be inputted, while this value is made smaller according to a simplicity level of an image to be inputted. This arrangement makes it possible for the user to easily and visually grasp the coded state. Further, by changing the display color of the coding rate according to the complexity of the image to be inputted, likewise, it is visually understood by the user that the coding noises appear and thus no well-performed coding cannot be carried out. Hence, the user gets to know this matter while recording an image, so that he or she can avoid this appearance of the coding noises if the position of the camera or the object may be adjusted.

In the stay-at-home model video recorder to which an optical disk or a hard disk drive is applied, this displaying means may be built in a character panel on which a watch or the like may be displayed. For a portable video camera, it is displayed on a view finder for achieving an optical framing operation.

The foregoing display being given according to the image being inputted provides a capability that the user of the apparatus may avoid the coding noises of the digital image coding representatively like the MPEG-2.

In the notice of the remaining time, for the varying coding rate, the remaining time is calculated by applying the maximum coding rate to be used for coding to the coding rate of the foregoing expression 1. In the expression 1, the remaining time calculated by using the maximum coding rate is the minimum remaining time in the case of recording the data at the maximum coding rate. Hence, if for a certain length of period a smaller coding rate than the maximum coding rate is used for recording, the remaining time is extended accordingly. However, the recording is continued at least for the remaining time calculated at the maximum coding rate.

The decreasing degree of the remaining time is varying depending on the magnitude of the coding rate. That is, as the coding rate is made larger, the pace of decreasing the remaining time is made lower, while as the coding rate is made smaller, the pace of decreasing the remaining time is higher. Hence, the display means is arranged so that the decreasing pace of the remaining time is notified together with the notice of the coding rate.

For this purpose, means of displaying a remaining time is provided for changing the display form for indicating the remaining time when the data is to be recorded on the recording medium according to the coding rate. That is, by viewing the change of the display form, the user can reach the magnitude of the coding rate.

For example, means is provided of changing a display color according to the coding rate. That is, by viewing the display color, the user can reach the magnitude of the coding rate.

As a result, for a display color for a larger coding rate, the decreasing pace of the remaining time is made larger. That is, the user can visually know that the remaining time is decreased faster. On the other hand, for a display color for a smaller coding rate, the means operates to notify the user of the fact that the decreasing pace of the remaining time is small and the remaining time is decreased slower.

The display of the coding rate is not limited to the change of the display color. It may be the change of the flashing pace of a display mark and the change of a display mark size. In any case, the magnitude of the coding rate may be notified by changing the form of the display.

Further, the remaining time is notified by not only a numeric value but also a graphic form. For example, the graphic form means the recording amount or time is indicated by a band-like bar graph and the area for indicating the “recorded” is made larger with the progress of recording the image data. For a larger coding rate, the pace of gradually increasing the area for indicating the “recorded” is made faster, while for a smaller coding rate, the pace of gradually increasing the area for indicating the “recorded” is made slower. This makes it possible to notify the user of the magnitude of the coding rate and the decreasing pace of the remaining time.

The foregoing notice will be described with another representation. The non-recorded area or the recordable time is indicated by a band-like bar graph and the area for indicating the “non-recorded” is made gradually smaller with the progress of recording the image data. For a larger coding rate, the pace of gradually decreasing the area for indicating the “non-recorded” is made faster, while for a smaller coding rate, the pace of gradually decreasing the area therefor is made slower. This makes it possible to notify the user of the magnitude of the coding rate and the decreasing pace of the remaining time.

In place, the foregoing notice may take means of representing both the recorded area and the non-recorded area at a time. In this case, the total volume of the recording medium is pre-displayed as securing a portion of a certain length by the band-like bar graph, and the area for indicating the “recorded” is made larger and the area for indicating the “non-recorded” is made smaller according to the progress of recording the image data.

Herein, the recordable remaining time when the data is to be recorded on the recording medium means an amount of the information to be written on the area of the recording medium where no information is recorded, that is, new information is to be recorded.

Therefore, the remaining time is not limited to the concrete numeric value such as a hour, minute and second. In place, if the recorded area and the non-recorded area are displayed, a rate of the magnitudes of both areas allows the non-recorded area size to be relatively displayed. That is, for this type of display, the remaining time is represented without using the concrete numeric values like a hour, minute and second.

Other objects, features and advantages of the invention will become apparent from the following description of the embodiments of the invention taken in conjunction with the accompanying drawings.

### BRIEF DESCRIPTION OF THE DRAWINGS

FIG. 1 is a circuit block diagram showing a video camera to which an optical disk is applied;

FIG. 2 is a circuit block diagram showing an MPEG-2 encoder;

FIG. 3 is a graph showing a characteristic of a coding rate to an input image;

FIG. 4 is a view showing an example of a display of a recording finder provided with a video camera according to the present invention;

FIG. 5 is a view showing an example of a display lamp provided with a video camera according to the present invention;

FIG. 6 is a flowchart showing a process of calculating a remaining time;

FIG. 7 is a view showing an example of a display of a remaining time according to the present invention;

FIG. 8 is a view showing an example of a display of a remaining time according to the present invention; and

FIG. 9 is a view showing an example of a display of a remaining time according to the present invention.

### DETAILED DESCRIPTION OF THE EMBODIMENTS

As an example of an application of the present invention to an apparatus of recording and reproducing a digital video signal, as described above, a stay-at-home model optical recording apparatus or a recording apparatus having a HDD (Hard Disk Drive) as a recording medium for mainly recording a TV program may be considered. Further, a portable video camera recorder provided with this recording medium has been already developed with a help of the state-of-the-art minute LSI technology and small-sized light pickup. In particular, the video camera is often used to record an object that is important to its user or an extraordinary event, which indicates focus is often placed on the storage durability and the quality of a recorded image.

A practically developed video camera is arranged to use the currently developed digital compression technology and includes a 12:1 zoom lens, a CCD sensor consisting of one million to one million and two hundred thousand pixels, a camera signal treatment through the use of a 0.18 μm CMOS technology, an MPEG-2 system served as a digital coding system, and a 8-cm DVD-RAM (Digital Versatile Disc Random Access Memory) served as a recording medium.

The video camera is basically used not for recording a pre-imaged data like a TV program but for an object to be intended by its user. It means that since the opportunity of imaging an object is limited, the excellent quality of image is required to be recorded without fail. Moreover, the video camera is generally arranged to supply a video image processed through a camera signal processing circuit. In actual, however, the conventional video camera has no means of notifying the user of whether or not the coding noises appear in compressively coding the video signal. According to the present invention, however, before imaging an object, an imaging action like trial imaging makes it possible to check if the coding noises appear. The check for the noises is used for selecting the coding rate as a reference or the user's adjustment of an object.

In the present embodiment, a digital video camera will be described in detail.

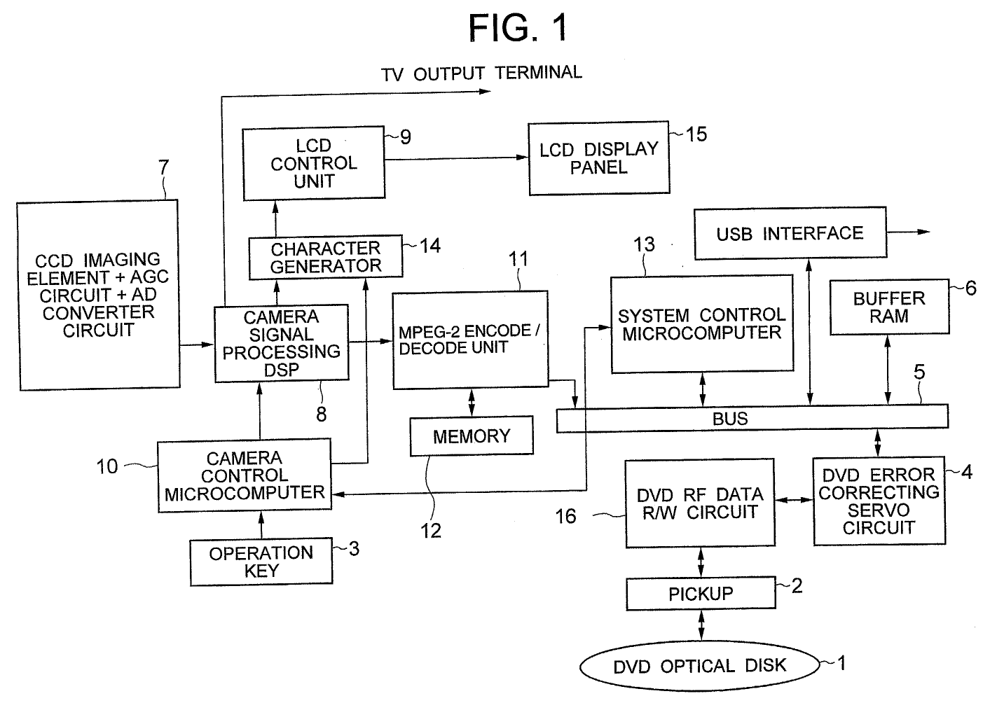

FIG. 1 is a circuit block diagram showing a video camera for digitizing an inputted image through the use of the MPEG-2 system and recording the digital image. A reference number 1 denotes an optical disk recording medium like a DVD. The recording medium usually has a diameter of 12 cm. Since the data is recorded from the inner to the outer, a small-sized disk like a 8-cm disk is also normalized. The optical disk is fitted to a case shaped to the disk and then the case is loaded to the video camera for the purpose of protecting the optical disk, though some video cameras receive the optical disk as it is. A reference number 2 denotes a pickup for writing and reading a signal of the optical disk like the DVD. A reference number 3 denotes an operation key for recording and reproducing the data on and from the optical disk. A reference number 7 denotes a block composed of a CCD imaging element, an AGC circuit and an AD converter circuit for converting light imaged through an optical lens into an electric signal, automatically adjusting the amplitude level of the electric signal, and converting the adjusted signal into a digital signal. A reference number 4 denotes an integrated circuit of a circuit for executing a tracking, a focusing, and a spindle servo operation of the optical disk like the DVD and an error correcting circuit for writing and reading the data. A reference number 8 denotes a DSP circuit for processing a video camera signal. A reference number 10 denotes a camera control microcomputer. A reference number 11 denotes an MPEG-2 encode/decode unit. A reference number 13 denotes a system control microcomputer. A reference number 15 denotes a view finder for displaying an object image inputted through the lens or a reproduced image, the finder being normally composed of a liquid crystal panel. The LCD display panel 15 measures 2 to 4 inches diagonally so that the image data recorded on the disk may be easily checked when it is reproduced.

In turn, the description will be oriented to the flow of a signal and the process of each block to be executed in imaging an object with reference to the circuit block diagram of a video camera shown in FIG. 1.

An optical image of an object picked up by the optical lens is optical/electrical converted into an electrical signal through the effect of the CCD imaging element, the AGC circuit and the AD converter circuit 7. In this conversion, the change of the signal level in the optical system is set to the predetermined signal level by the AGC circuit and is converted into the digital signal through the AD converter circuit 7. Then, the digital signal is inputted to a camera signal processing DSP 8. The signal obtained from the block 7 composed of the CCD imaging element, the AGC circuit and the AD converter circuit 7 is the signal read according to the physical location of the CCD sensors. Hence, the camera signal processing DSP 8 operates to convert the digital signal into a luminance signal and the Y, U and V signals of a color signal, which are known as the normal video signal format. The converted signal is enhanced and then is outputted. Further, the camera signal processing DSP 8 also operates to generate a driving pulse required for the block 7 of the CCD imaging element, the AGC circuit and the AD converter circuit 7 and a synchronous signal required for the video output and then supply these signals to each unit of the video camera. The camera control microcomputer 10 served as a camera control unit operates to control the camera signal processing DSP 8 at the most approximate mode according to the zoom and focus locations of the lens, though not shown, on the basis of the image information obtained from the block 7, and the information obtained by the operation key 3. As another kind of information, the analog signal outputted from an angular speed sensor composed of a gyroscopic sensor or the like is A/D converted into the corresponding digital signal and then is inputted into the camera control microcomputer 10. The signal from the angular speed sensor is used for controlling the driving pulse of the CCD imaging element, for stabilizing the shaking image as much as possible.

The digital video signal obtained from the camera signal processing DSP 8 is sent as a 16-bit parallel data to the MEPG-2 encode/decode unit 11. The 16-bit parallel data is just an example in this embodiment. The MPEG-2 encode/decode unit 11 operates to expand the image of the camera signal processing DSP 8 with a memory 12 as an image memory and then compress the moving image data by a factor of 1/60 or some. The compressed image data is outputted to a system internal bus 5 in accordance with an instruction given by the system control microcomputer 13. On the other hand, the speech signal, though it is not shown, is obtained by a microphone built in the video camera and then is A/D converted into the corresponding digital signal. The digital signal is compressed through the software run in the system control microcomputer 13. The compressed signal is made to be an MPEG signal stream. On the other hand, the system control microcomputer 13 operates to multiplex the image data outputted from the MPEG-2 encode/decode unit 11, the image stream and the speech stream through the use of the software. The multiplexed signal is made to be an MPEG data stream. This MPEG data stream is temporarily stored in a buffer RAM for several seconds for the purpose of avoiding a temporary stop of write by such a write error as causing a blur inside the optical disk like the DVD and a head seek. Then, the MPEG data stream passes through the system internal bus 5 and then is sent to a DVD optical disk signal processing circuit composed of a DVD error correcting servo circuit 4 and a DVD RF data R/W circuit 16. As mentioned above, the reference number 4 denotes an integrated circuit of a circuit for executing a tracking, a focusing, and a spindle servo operation of the optical disk like the DVD and an error correcting circuit for writing and reading the data. The MPEG data stream is processed by the DVD error correcting servo circuit 4 into the data format according to the DVD standard. Then, the correcting codes are added to the processed signal also by the circuit 4. The resulting signal is digitally modulated by the DVD RF data R/W circuit 16 and then is recorded on the DVD disk 1 by the pickup 2.

Then, the description will be oriented to the operation of reproducing the image data from the DVD disk 1. Basically, the reproducing operation flows the signal in the reverse manner to the foregoing recording operation. At first, the pit data on the DVD disk 1 is read as a digitally modulated data by the pickup 2. Then, the DVD RF data R/W circuit 16 operates to perform a waveform equalization about the digital pit data and detect the servo signal thereof. Then, the DVD error correcting servo circuit 4 operates to output the data signal processed by the data R/W circuit 16 as the MPEG-2 image stream into the system internal bus 5. The transfer of the image and the speed data on the system internal bus 5 are controlled under the instruction given by the system control microcomputer 13. The image and speech data are expanded and restored into the original image data through the use of the MPEG-2 encode/decode unit 11. Like the recording operation, the data is converted into the video signal like a PAL signal or an NTSC signal through the effect of the camera DSP 8 by means of the 16-bit parallel signal. Then, the video signal passes through a character generator 14 for generating on-screen characters and an LCD control unit 9 and then is displayed as a reproduced image on the LCD display panel 15. Likewise, the camera signal processing DSP 8 operates to supply the NTSC or the PAL video signal so that the resulting image may be outputted from the video output terminal and displayed on the outside display unit.

Herein, the description will be oriented to the operation of recording and reproducing the moving picture according to the MPEG-2 system. The video camera of this embodiment enables to image and record a still picture according to the JPEG system. The encoding operation in the JPEG system is substantially same as the one-picture encoding operation in the MPEG system. The MEPG-2 encode/decode unit 11 may be served as the JPEG system encoder merely by switching a partial operation of the encode/decode unit 11 itself. The still picture outputted from the MPEG-2 encode/decode unit 11 is recorded as one file on the DVD disk 1.

In the video camera to which the present invention applies important are the operation of the MPEG-2 encode/decode unit 1 for high-efficiently coding the video signal obtained from the block 7 of the CCD imaging element, the AGC circuit and the AD converter circuit 7 and the camera signal processing DSP 8 according to the MPEG-2 standard and the operation of the system control microcomputer 13 for driving and controlling the MPEG-2 encode/decode unit 11. When the user of the video camera operates the operation key 3, the system control microcomputer 13 is required to start the recording operation and control the MPEG-2 encode/decode unit 11 so that the MPEG-2 data may be generated at a predetermined coding rate. Further, the system control microcomputer 13 is also required to constantly grasp the remaining volume of the DVD disk 1 through the DVD error correcting servo circuit 4 and indicate the presumed remaining recordable time on the LCD display panel 15, that is, the user of the video camera.

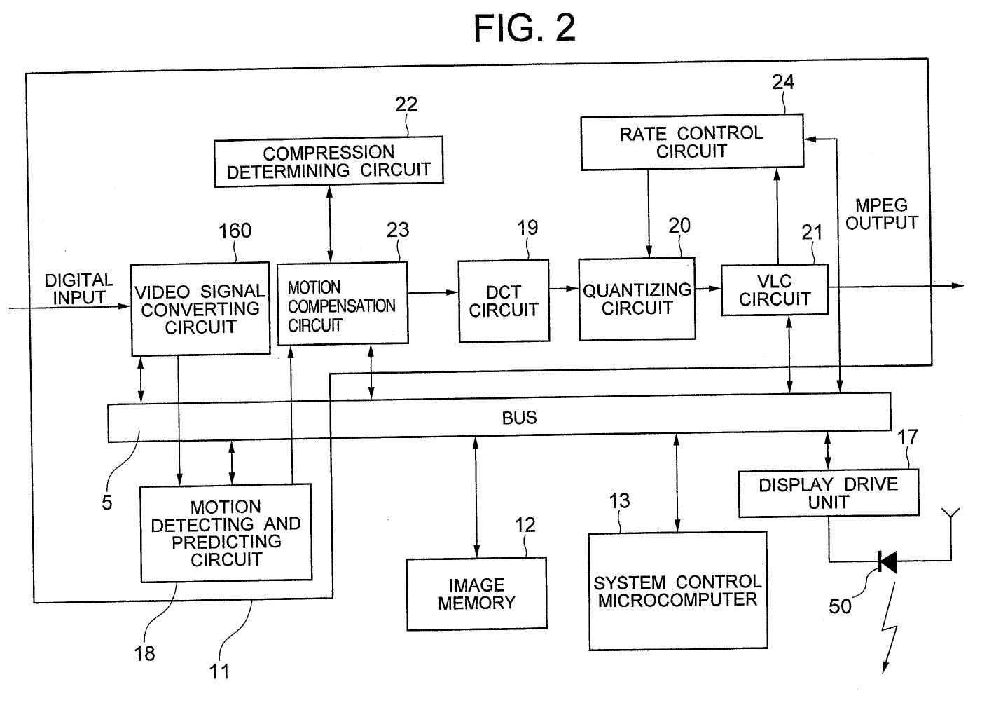

FIG. 2 is a circuit block diagram showing the internal of the MPEG-2 encode/decode unit 11 in detail. The portion of controlling the coding rate through the MPEG-2 encode/decode unit 11 and the system control microcomputer 13 will be described in more detail.

In order to improve the quality of the image to be recorded, if the inputted image is a complicated one with great motion components and horizontal and vertical high-frequency components in the video signal, generally, the video camera of the MPEG-2 system operates a rate control circuit 24 according to the inputted image so that the camera may record the image as sequentially varying the coding rate. In this operation, the video camera is required to keep a higher coding rate than that at which the image quality is excellent enough to be that of the home video camera.

The system internal bus 5 and the system control microcomputer 13 are the same as those shown in FIG. 1 and thus have the same reference numbers. In FIG. 2, the MPEG-2 encode/decode unit 11 is enclosed by a frame, which indicates the internal block of the MPEG-2 encode/decode unit 11 shown in FIG. 1. The image data digitized by the camera signal processing DSP 8 shown in FIG. 1 is inputted into the video converter circuit 160 and is converted so as to facilitate the coding along the HYPERLINK mailto: MP@ML MP@ML (Mail Profile at Main Level 1) of the MPEG-2 standards. The image data outputted from the video converter circuit 160 is applied into a motion detecting and predicting circuit 18 in which the motion of the imaging data is detected and the motion vector is extracted. The extracted motion vector is applied to a motion compensating circuit 23. The circuit 23 operates to generate difference data between a reference image shifted from the images before and after the object image by the motion quantity based on the motion vector and another reference image extracted from the image data, called a template and then to add the difference data into a frequency converter circuit called a DCT (Discrete Cosine Transform) circuit 19. At this time, the image data is sent from the video converter circuit 160 to the image memory 12, the motion detecting and predicting circuit 18 and the motion compensating circuit 23 through the system internal bus 5 connected inside the MPEG-2 encode/decode unit 11. A reference number 22 denotes a data compression determining circuit having a function of selecting the most efficient image frame in the case of detecting the difference between the image motions. The DCT circuit 19 enables to extract the frequency components of the image by performing a DCT operation about the video signal. When the inputted image contains a large flat area, that is, the low frequency components, the output of the DCT circuit 19 becomes the image data with lots of low frequency components. On the other hand, if the inputted image contains lots of fine portions, the output of the DCT circuit 19 becomes the image data with lots of high frequency components. A reference number 20 denotes a quantizing circuit which operates to digitally thin out the image data decomposed into the frequency components outputted from the DCT circuit 19, in particular, the high frequency components of the image data for quantizing the image data. The reduction of a thinning amount leads to quantizing the image data outputted from the DCT circuit 19 with fidelity. In this case, the resulting image is made to be a high-definition image precisely conforming with the inputted image. On the contrary, the widening of a thinning interval leads to reducing the coding rate, thereby improving the overall compression rate of the MPEG-2 encode/decode unit 11 and impairing the quality of image. In the case of applying the present invention to the recording and reproducing apparatus for an optical disk, for example, as mentioned above, the coding rate to be used is limited. For example, for the home video camera, if the coding rate is limited to 6 Mbps and the inputted image is complex, the foregoing quantization brings about thinning of the image data outputted from the DCT circuit, which leads to lowering the fidelity to the inputted image. It means that the phenomenon called the coding noises takes place. This coding noises indicate that a discontinuous encode image is caused by a luminance distortion, that is, a luminance step between the macro blocks, at which macro block the image data is treated by the DCT circuit 19. The image with the coding noises is made different from the natural image. Hence, the coding noises are known as an uncomfortable factor. Then, a VLC (Variable Length Code) circuit 21 is a circuit which compresses the quantized codes according to the rule called the variable-length coding. The output of the VLC circuit 21 is made to be the final data to be recorded on the recording medium like the optical disk. At this time, the system control microcomputer 13 is required to control the coding rate generated by the overall MPEG-2 encode/decode unit 11 per unit time. The system control microcomputer 13 operates to send an indication to the rate control circuit 24 according to the coding rate at which the resulting image quality is excellent enough to be the image quality of the home video camera, for controlling the data thinning amount of the quantizing circuit 19. Herein, the system control microcomputer 13 operates to constantly monitor if the thinning amount exceeds such a threshold value as bringing about the critical amount of the coding noises. The system control microcomputer 13 operates to set the thinning amount increased by 20% from the proper thinning amount of 6 Mbps, which is used for the ordinary recording, obtain the information from the rate control circuit 24 at each GOP (Group Of Picture) of the MPEG, compare the obtained information with the set thinning amount, and thereby detect if the thinning amount enters into an area where the coding noises are likely to appear. When it is detected, the system control microcomputer outputs a predetermined command to the system internal bus 5 for controlling a display driving circuit 17 to indicate a display circuit 50 composed of LED's to light up the red LED's. This allows the user of the video camera to determine if the status being currently imaged brings about the disadvantageous image quality from a viewpoint of the coding noises. For example, in the area where the stable image can be obtained, lower than the area where the coding noises are likely to appear, by activating on or off the green LED, it is possible to notify the user of the current recording state. On this notice, the user can select the object so that the LED is constantly off or the green LED is on, stabilize the camera, and switch the coding rate of the video camera, that is, select the image quality switching mode. In order to protect the image quality from the impairment by the coding noises, the user can record his or her important image at the low coding rate mode as a trial, recognize that the display is light red, then switch the coding rate to a higher one, and image the object again without having to lower the image quality by the coding noises if the circumstances of the user or his or her object permit.

Unlike the system shown in FIG. 2, the system without the display driving circuit 17 and the display 50 may be considered. As shown in FIG. 1, the video camera normally provides the LCD display panel 15 and the character generator 14. By using the panel 15 and the generator 14, the information detected by the MPEG-2 encode/decode unit 11 and the system control microcomputer 13 is communicated to the camera control microcomputer 10 so that the character generator 14 may be controlled and the state of the coding rate may be displayed on the LCD display panel 15. This makes it possible to provide the display function of the invention without having to add quite new hardware.

In this embodiment, a CBR (Constant Bit Rate) system for recording an image at 6 Mbit per second is provided in light of the limitation of the recording time caused by the volume 1.46 GB of the 8-cm DVD disk and the image quality requested by the home video camera. On the other hand, at the VBR (Variable Bit Rate) mode at which the coding rate is sequentially varying, the image may be recorded at 8 Mbit as maximum or 4 Mbit as minimum according to the motion and the complexity of the image to be recorded. Herein, the apparatus for compressing, coding and recording the video signal, in particular, the apparatus provided with the MPEG-2 standards HYPERLINK mail to: MP@ML MP@ML (Main Profile@Main Level 1) and an 8-cm optical disk with a recording volume of 4.7 GB or 1.46 GB on a single side has difficulty in setting the constant bit rate to 10 Mbps or more, because the recording time of the optical disk of 4.7 GB is about one hour or the recording time of the 1.46 GB optical disk is about 18 minutes, which are not practical to the video camera. In this case, the recording coding rate is normally set to 5 to 7 MBs. It is known that this kind of value is such a recording coding rate as obtaining the image quality to be used for broadcasting.

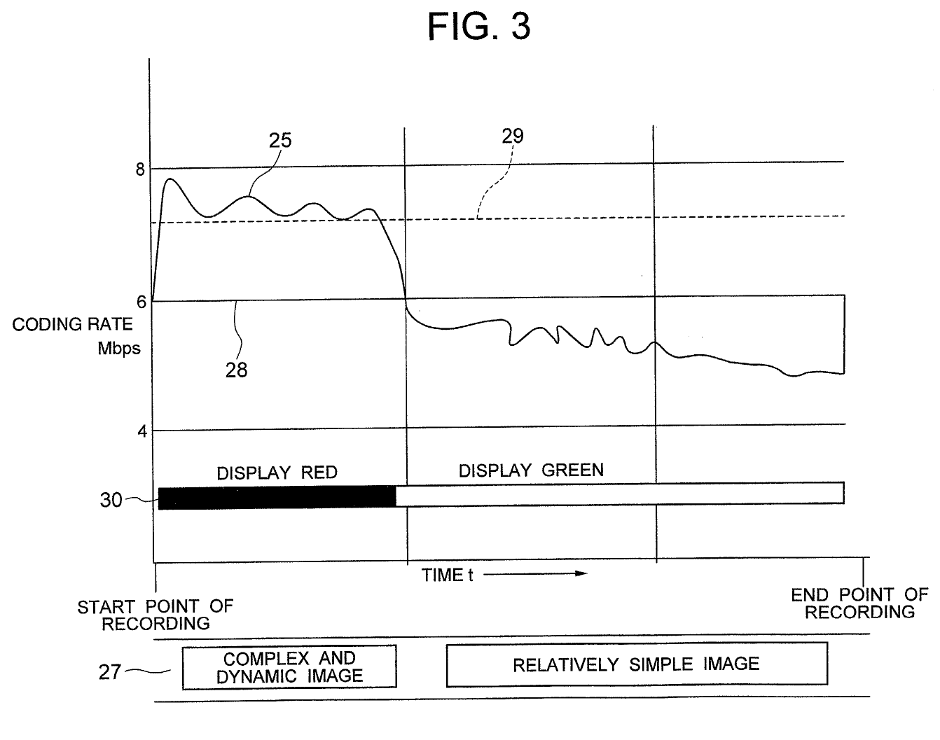

In turn, the description will be oriented to the operation of the display function of the invention for the inputted image on a time with reference to FIG. 3. In a case that a complex and dynamic image is inputted as indicated by 27 in FIG. 3, in particular, at the CBR (Variable Bit Rate) mode as indicated by 28, the coding rate used for recording cannot be increased, so that the coding noises are more likely to appear. Further, even at the VBR (Variable Bit Rate) mode indicated by 25, as mentioned above, the practical limitation of the recording time becomes an obstacle to setting the coding rate to 10 Mbs or more. It means that the far larger coding rate for recording may bring about the coding noises against a specific image existing in the natural world. A reference number 29 denotes a line for indicating a threshold value on which it is determined if the coding noises are likely to appear, which is the feature of the invention. In this case, the coding rate is set to about 7 Mbps. For example, in a case that a complex and dynamic image is recorded at the coding rate 25 of the VBR mode, the coding rate may exceed the line of 29. The system control microcomputer 13 shown in FIG. 2 operates to obtain the information from the rate control circuit 24 for each GOP (Group Of Pictures) of the MPEG system and determine that the coding rate exceeded the line 29. Then, the microcomputer 13 operates to control the display driving circuit 17 so that it may notify the user of the video camera of the information that the recording is not excellent.

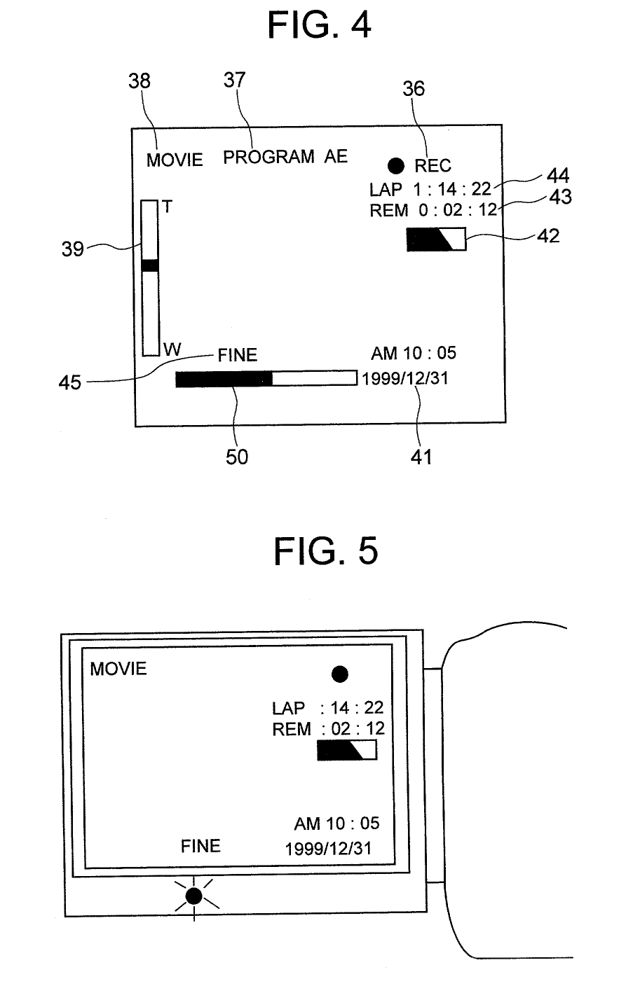

Then, FIG. 4 illustrates a display screen of a view finder for determining a liquid crystal monitor screen or the object framing of the home video camera provided with the display function of the invention and the MPEG-2 encode/decode unit. A reference number 36 denotes an operation mode such as a recording operation or a reproducing one. A reference number 37 denotes a program AE mode in operation for executing an automatic control such as an exposure control or a shutter speed control according to the target object or the user's intention. A reference number 38 denotes a “motion picture/still picture” switching mode at which the motion picture and the still picture may be recorded, because the camera with the recording medium like the optical disk enables to record lots of still pictures. A reference number 39 denotes a zoom bar that appears in optical or electronic zooming. A reference number 45 denotes a mode selection of the recording coding rate. A reference number 50 denotes a feature of the present invention. In this embodiment, if the complexity of the object or the image to be inputted to the camera is low, the display bar 50 is displayed white or green. If the complexity of the image to be inputted to the camera is high and the image is coded in a manner that the coding noises are generated when the camera is in the recording state, the display bar 50 is moved to the right hand and the overall color is changed to a red or magenta color. This prompts the user of the camera to be careful of recording. A reference number 41 denotes a date and time when the object is imaged. A reference number 42 denotes a remaining volume of the battery. A reference number 43 denotes the remains of the recording time of the recording medium. A reference number 44 denotes a passage time from the start of recording.

The user of the video camera enables to change an angle of an object or avoid another object with lots of high frequency components in the background of the object when imaging the object as viewing the state of the display 50. In a case that the video camera to which the present invention applies records the image data at the CBR (Constant Bit Rate), if the target coding rate may be changed, as viewing the display 50, the user of the camera enables to enhance the target value of the CBR to a certain degree if the object to be imaged may often bring about a red display. Further, though this is an effect in light of the user's feeling, the display 50 offers a sense of reliability because it allows the user to effectively image the object even if only one change of imaging it is given.

FIG. 5 illustrates the arrangement in which a two-color LED are provided as the display lamp included in the display 51 around the view finder or within the operation panel in comparison with the arrangement of FIG. 4 in which the invention is applied to the view finder. Though this is the functionally same as the arrangement of FIG. 4, the display lamp is located not inside the view finder but around it. This location allows the user to more effectively recognize the function. It means that as more clearly monitoring if the imaging state is excellent, the user enables to continue the imaging. Apparently, since the monitor is not always necessary, the operation mode of “turn off display” may be provided for stopping the display 50 or 51.

Though FIGS. 4 and 5 illustrates the arrangement of the home video camera to which the present invention applies, the present invention may be applied to a stay-at-home model video recorder. For example, while the video recorder is recording, the noticing functions like the displays 50 and 51 allow the user of the video recorder to optionally select the recording coding rate of the video recorder. This is the substantially same as the effect that as monitoring the speech recording level of the speech recording deck on a display indicator, the user adjusts the recording level.

In this embodiment, the user is notified of appearance of the coding noises or a great possibility thereof according to the complexity of the inputted image or the object of the camera. Hence, if the user has a capability of grasping the information thereabout while recording the object or the image and switching the coding rate so that the appearance of the coding noises may be avoided, the coding rate may be adjustably switched so that the appearance of the coding noises may be avoided.

It goes without saying that the foregoing function holds true to the information recording apparatus such as the home video camera or the stay-at-home model video recorder.

In turn, the description will be oriented to the way of displaying the remaining quantity.

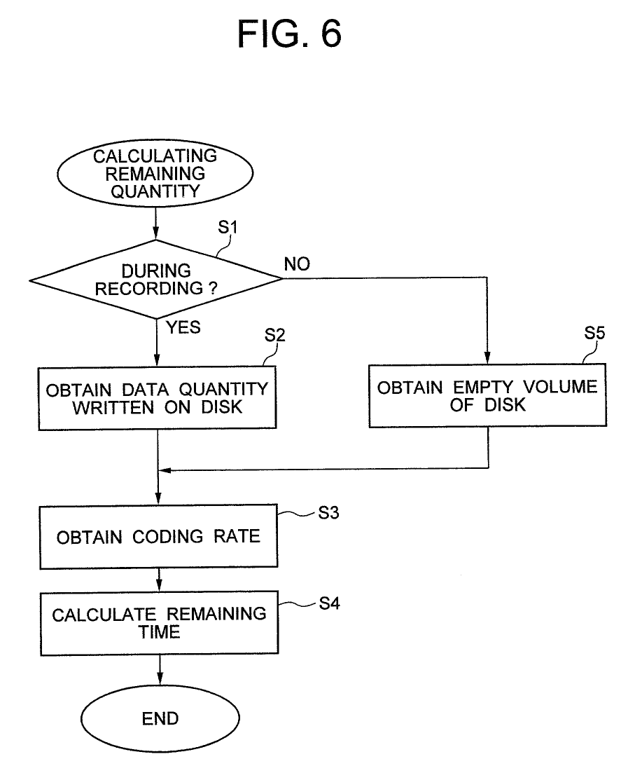

FIG. 6 is a flowchart for obtaining the process of deriving the remaining time.

In FIG. 6, in step S1, it is determined whether or not the apparatus is in recording. If yes, the process goes to a step S2, while if not, the process goes to a step S5.

If the apparatus is in recording, in the step S2, the process is executed to obtain the quantity of the data written on the disk. Then, in step S3, the coding rate is obtained. In step S4, the remaining time is calculated from the foregoing expression 1. If the coding rate is varying, the calculation is executed with the usable maximum coding rate. Hence, the process is executed to always calculate the recordable minimum remaining time.

If the apparatus is not in recording, in the step S, the process is executed to obtain an empty volume of the disk. Then, in the step S3, the coding rate is obtained. In the step S4, the remaining time is calculated by the expression 1. If the coding rate is changed while the recording is stopped, it is possible to derive the remaining time according to the coding rate.

In order to more efficiently derive the remaining time, it is just necessary to execute the routine of calculating the remaining time at certain time intervals, for example, every one second or every 1/60 second.

Though the coding rate is obtained in the step S3, it is not limited to the step S3 as shown in FIG. 6. However, before calculating the remaining time with the expression 1 in the step 4, it is necessary to obtain the coding rate. However, the coding rate is not inevitably required to be obtained. For example, a flag may be provided for indicating the change of the coding rate. In a case that the coding rate is varied, the flag is changed, when the coding rate may be obtained. If the flag is not changed, in the step S4, it is just necessary to calculate the remaining time by using the expression 1 to which the same coding rate is substituted.

In turn, the description will be oriented to the embodiment in which the coding rate and the decreasing pace of the remaining time are visually displayed.

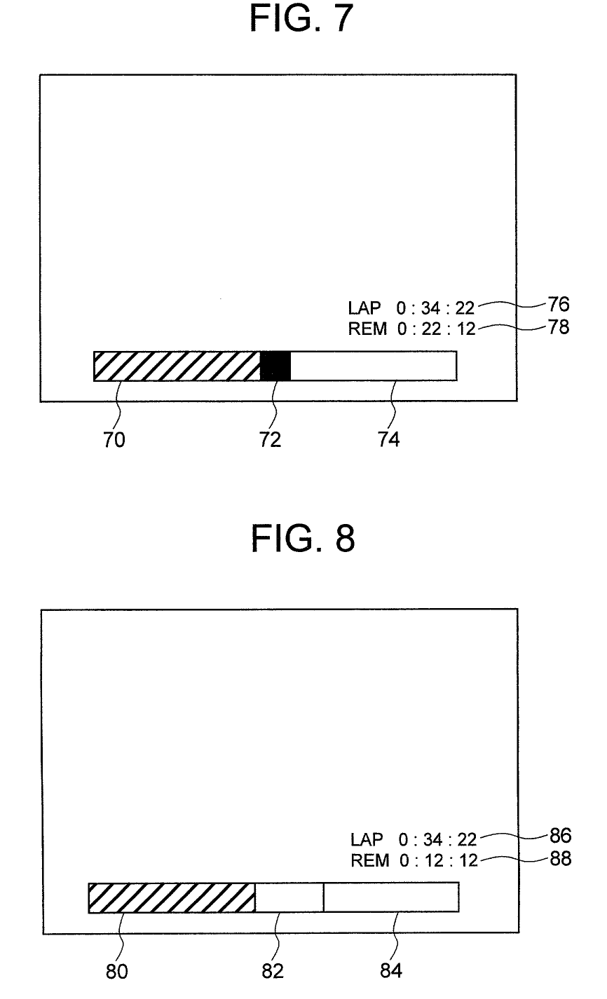

FIG. 7 illustrates the display of the remaining time on the camera finder. A reference number 70 denotes a recorded portion. A reference number 72 denotes a recording head portion. A reference number 74 denotes a non-recording portion. A reference number 76 denotes a passage time from the start of recording. A reference number 78 denotes a remaining time of the recording medium. In FIG. 7, if the coding rate is large, the recording head portion is made to be red, while if the coding rate is small, it is made to be blue. Hence, the user can easily grasp the magnitude of the coding rate through the color.

As the recording is advancing, the recording head portion 72 is moved to the right hand and the non-recording portion 74 is sequentially made smaller. For a larger coding rate, the recording head portion 72 is quickly moved to the right hand, while for a smaller coding rate, the recording head portion 72 is slowly moved to the right hand. This movement allows the decreasing pace of the remaining time to be easily displayed to the user's eyes.

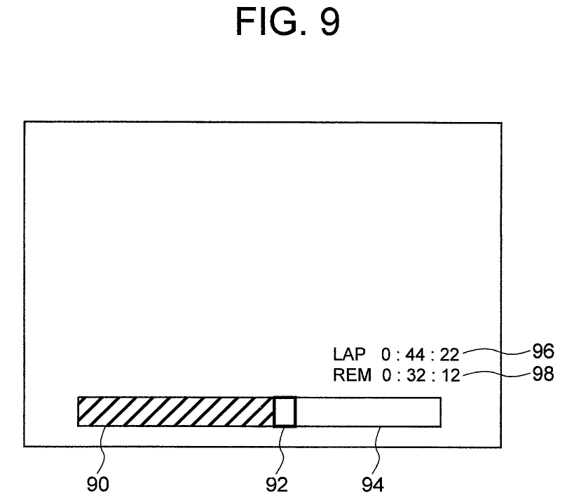

FIGS. 8 and 9 illustrate the remaining time. Like FIG. 7, A reference number 80 or 90 denotes a recorded portion. A reference number 82 or 92 denotes a recording head portion. A reference number 84 or 94 denotes a non-recording portion. A reference number 96 or 96 denotes a passage time from the start of recording. A reference number 88 or 98 denotes a remaining time of a recording medium.

In FIG. 8, for a larger coding rate, the width of the recording head portion 82 is made thick, while in FIG. 9, for a smaller coding rate, the width of the recording head portion 92 is made thin. This thickness of the width allows the user to visually grasp the magnitude of the coding rate with ease. Like FIG. 7, also in FIGS. 8 and 9, the display may be arranged so that for a larger coding rate, the recording head portion 82 or 92 is quickly moved to the right hand, while for a smaller coding rate, the recording head portion 82 or 92 is slowly moved to the right hand. This allows the user to easily grasp the decreasing space of the remaining time.

According to this embodiment, by displaying the remaining volume of the non-recording area of the recording medium and the coding rate in association therewith, it is possible to more understandably notify the user of the remaining volume and the decreasing pace of the remaining time. For example, in the imaging device like the camera, in the case of recording the image, the user of the imaging device enables to sensitively predict the remaining recordable time of the recording medium with the decreasing pace of the remaining time based on the notified remaining time. Hence, the exchange of the recording medium may be prepared with reference to the sensitively predicted remaining time. This also improves the convenience of use even in the recording operation with the variable coding rate.

In the foregoing arrangement of the embodiment, for indicating the magnitude of the coding rate, the display means may be used or means of displaying the coding rate may be newly provided.

Further, in the foregoing arrangement, for indicating the remaining recordable time of the recording medium, the display means may be used or means of indicating the remaining recordable time may be newly provided.

In order to vary the display form of the coding rate displaying means or the remaining time displaying means according to the magnitude of the coding rate, means of comparing the coding rate value with a predetermined value may be newly provided. This comparing means may be implemented by the software inside the control means like the system control microcomputer for controlling the signal processing in the image recording apparatus.

Moreover, the hardware required by this embodiment, for example, the means of displaying information on the view finder when recording a target object may be composed by a device for executing a basic operation of the video camera provided with an optical disk. Hence, it never increases the cost of the hardware. The use of the software for that purpose is smaller in light of a program volume in comparison with the firmware for controlling the optical disk or the software for retrieving the inside of the optical disk.

In addition, the foregoing description has been expanded with reference to the optical disk or the hard disk drive as the recording medium. It goes without saying that the recording medium is limited not only to those medium but to a memory.

The present invention provides means of avoiding unnatural noises called the coding noises. The user of the video camera or the video recorder to which the optical disk applies, therefore, enables to obtain the recording or reproducing image with a smaller quantity of noises than the conventional apparatus. Further, the use of the invention makes it possible to notify the user of the decreasing pace of the remaining volume of the recording medium.

It should be further understood by those skilled in the art that the foregoing description has been made on embodiments of the invention and that various changes and modifications may be made in the invention without departing from the spirit of the invention and the scope of the appended claims.

What is claimed is:

1. An image recording apparatus comprising:
means for coding an video signal;
means for recording coding information obtained from said coding means on a recording medium;
means for displaying a magnitude of a coding rate of said coding means; and
said means for displaying a coding rate varying the form of the display according to the magnitude of said coding rate.

2. An image recording apparatus as claimed in claim 1, wherein the coding rate of said coding means is compared with a predetermined value and the display form of said coding rate displaying means is changed on the compared result.

3. An image recording apparatus as claimed in claim 1, wherein said means for displaying a coding rate varies a display color according to the magnitude of said coding rate.

4. An image recording apparatus as claimed in claim 1, wherein the value of coding rate of said means for displaying a coding rate varies according to the magnitude of the coding rate of said coding means.

5. An image recording apparatus as claimed in claim 1, further comprising:
means for displaying a remaining time when data is to be recorded on said recording medium; and
wherein said means for displaying a remaining time serves to vary the display form according to the magnitude of said coding rate.

6. An image recording apparatus as claimed in claim 5, wherein said coding rate value of said coding means is compared with a predetermined value and said means for displaying a remaining time serves to vary the display form based on said compared result.

7. An image recording apparatus as claimed in claim 5, wherein said means for displaying a remaining time serves to vary the display color for indicating the remaining time.

8. An image recording apparatus as claimed in claim 5, wherein said means for displaying a remaining time serves to vary the display size based on the quantity of the coding information to be recorded on said recording medium.

9. An image recording apparatus as claimed in claim 5, wherein means for displaying a remaining time serves to change the display color according to the magnitude of said coding rate.

10. An image recording apparatus as claimed in claim 5 or 6, wherein said means for displaying a remaining time serves to change the display size according to the magnitude of said coding rate.

11. An image recording apparatus as claimed in claim 5, wherein said means for displaying a remaining time serves to change the flashing times of the display per unit time according to the magnitude of said coding rate.

12. An image recording apparatus as claimed in claim 1, further comprising:
a camera optical system;
means for processing a signal sent from said camera optical system;
finder means for viewing a target object; and
a power supply circuit.

13. An image recording apparatus comprising:
means for compressing and coding an video signal as varying a coding rate according to a complexity of said video signal and saving said compressed and coded codes on a recording medium; and
means for displaying if the coding rate of the coded video signal is larger than or smaller than a predetermined coding rate.

14. An image recording apparatus as claimed in claim 13, wherein said means for compressing and coding a video signal serves to increase a display value for the coding rate if the coding rate is made greater according to the complexity of an image or decrease a display value for the coding rate if the coding rate is made smaller according to the simplicity of an image.

15. An image recording apparatus as claimed in claim 13, wherein said means for compressing and coding a video signal serves to increase the coding rate according to the complexity of an image and vary a display color for the coding rate if said coding rate exceeds said predetermined coding rate.

16. An image recording apparatus as claimed in claim 15, wherein said means for compressing and coding a video signal serves to increase the coding rate according to the complexity of an image and change a display color for the coding rate into a red color if said coding rate exceeds said predetermined coding rate.

17. An image recording apparatus comprising:
means for compressing and coding a video signal and fixing a coding rate independently of the complexity of said video signal by varying a compression factor according to the complexity of a video signal to be inputted and recording said compressed and coded codes on a recording medium; and
means for displaying whether or not said compression factor exceeds a predetermined value.

18. An image recording apparatus as claimed in claim 13, further comprising:
an optical lens;
means for processing a camera signal;
finder means for defining a view angle for a target object; and
a battery.

19. An imaging recording apparatus as claimed in claim 17 further comprising:
an optical lens;
means for processing a camera signal;
finder means for defining a view angle for a target object; and
a battery.

20. An image recording apparatus as claimed in claim 17, wherein said means for compressing and coding a video signal serves to increase a compression factor according to the complexity of an image and to change a display color for the compression factor if said compression factor exceeds said predetermined value.

21. An image recording apparatus as claimed in claim 17, wherein said means for compressing and coding a video signal serves to increase the compression factor according to the complexity of an image and to change a display color for the compression factor into a red color if said compression factor exceeds the predetermined value.
